(19) United States
(12) Patent Application Publication
(10) Pub. No.: US 2012/0278211 A1
(43) Pub. Date: Nov. 1, 2012

(54) METHODS, APPARATUSES AND SYSTEMS FOR VERIFYING TIME AND ATTENDANCE BY WORKERS AT REMOTE WORKSITES

(75) Inventors: Thomas Raymond Loveland, Springville, UT (US); Patrick F.T. Behrbom, Alpine, UT (US)

(73) Assignee: CORA SOFTWARE LLC, Provo, UT (US)

(21) Appl. No.: 13/094,733

(22) Filed: Apr. 26, 2011

(51) Int. Cl. G07C 1/00

(52) U.S. Cl. 705/32

(57) ABSTRACT

Systems, apparatuses and methods for remotely keeping track of, or monitoring, one or more individuals' work activities employ mobile phones or other mobile tracking devices used by the individuals. The mobile tracking devices convey verifiable time and location information to a central controller to confirm each individual's attendance at an assigned worksite at a scheduled time.

### TECHNICAL FIELD

The present invention relates generally to systems, apparatus and methods for tracking the amount of time an individual works and, more specifically, to systems, apparatus and methods for remotely verifying an individual's time at work. More specifically, the present invention relates to systems, apparatus and methods in which a mobile tracking device, such as a mobile telephone, is used to keep track of an individual's time at work.

### SUMMARY

The present invention includes, in various aspects, systems, apparatus and methods for keeping track of, or monitoring, one or more individuals' work activities. In more specific embodiments, systems, apparatus and methods of present invention may be configured to monitor workers' attendance at their assigned worksites, and the time each worker spends at his or her assigned worksite. Through the various aspects of the present invention, each individual's attendance and the time that individual spends at work may be tracked remotely.

In a method of the present invention, a worker reports to a work site. The work site may be remote from the location of the party that provides the worker with employment (e.g., an employer, contractor, etc.). For the sake of simplicity, the work-providing party is hereinafter referred to as a “provider.” Upon reporting to the work site, the worker remotely reports his or her presence at the work site to the provider. The report may include data confirming the time that the worker reports his or her presence at the work site, as well as evidence that the worker is actually present at the work site at the reported time. When the worker leaves the work site, the worker may report the same to the provider. In some embodiments, the provider may confirm that a worker remains present at the work site during an appointed work shift. Check-ups of this type may be conducted continuously or intermittently throughout the appointed shift.

The worker may use a mobile tracking device to report his or her presence at the work site. The mobile tracking device may generate one or more wireless signals, which may be transmitted from the work site. In addition the mobile tracking device may be equipped with one or more confirmation components that provide physical evidence of the worker's presence at the work site at the reported time. The confirmation components may include: features such as a camera and associated multimedia messaging service (MMS) capability; a global positioning system (GPS) transceiver and associated programming that causes the cellular telephone to transmit real-time data corresponding to the location of the cellular telephone and, presumably, the worker; a transmitter or detector that communicates with a complementary detector or transmitter at the work site; or any other feature that provides evidence that a worker is present at a work site when the worker reports to the work site. Alternatively, the worker may report his or her arrival at the work site with a mobile tracking device, while evidence of the worker's presence at the work site may be provided by separate apparatus (e.g., a camera, etc.) at the worksite.

Signals generated by the mobile tracking device may be ultimately (although not necessarily wirelessly) received by a monitoring station. The monitoring station receives a signal that a particular worker has reported to a job site at a particular time, as well signals that convey data that proves the worker is present at the work site at that time. The monitoring station includes a receiver for receiving signals generated by one or more mobile tracking devices, as well as a processor for processing data conveyed by the signals. The processor may be programmed to evaluate the data carried by the signals to verify, or at least provide a probability, that the worker is present at the work site, as reported. The processor may also store the data (e.g., in associated memory, etc.) for further evaluation, and may store information about the time the worker arrives at the work site, the time the worker leaves the worksite, and the duration of the worker's presence at the work site. In a specific embodiment, the monitoring station comprises a server or another computer.

A system that incorporates teachings of the present invention may include a plurality of mobile tracking devices to be provided to and used by a plurality of workers, a monitoring station used by the provider or a contractor who monitors workers attendance on behalf of the provider and a communications network, over which the plurality of mobile tracking devices communicate with the monitoring station.

In a specific embodiment, a mobile tracking device used in a method or of a system of the present invention may comprise a mobile telephone. In such an embodiment, the communication network over which the mobile telephone may communicate with the monitoring station may, at least in part, comprise a cellular network.

In some embodiments, the monitoring station, which is also referred to herein as a “central controller,” may comprise a dedicated system configured solely to keep track of one or more providers' workers. In other embodiments, worker time management may comprise one of any of a plurality of functions performed by the central controller, or monitoring station. Additional functions of the central controller may include, but are certainly not limited to, management of other aspects of a provider's business, such as worker scheduling, inventory management, analysis of customer data and evaluation of the relationships between the various functions of the central controller.

Other aspects, as well as the features and advantages of various aspects, of the present invention will become apparent to those of ordinary skill in the art through consideration of the ensuing description, the appended drawings and the accompanying claims.

### BRIEF DESCRIPTION OF THE DRAWINGS

In the drawings:

FIG. 1 schematically depicts embodiments of a system, including a plurality of mobile tracking devices and a monitoring station, that enables a provider (e.g., an employer, a contractor, etc.) to track a worker's time and attendance at a work site.

FIG. 2 is a flow chart that represents an embodiment of a method for tracking, or monitoring, a worker's time and attendance at an appointed location, work site, during an appointed period of time, or work shift; and

FIG. 3 is a flow chart representing further acts in a time and attendance tracking method of the present invention.

### DETAILED DESCRIPTION

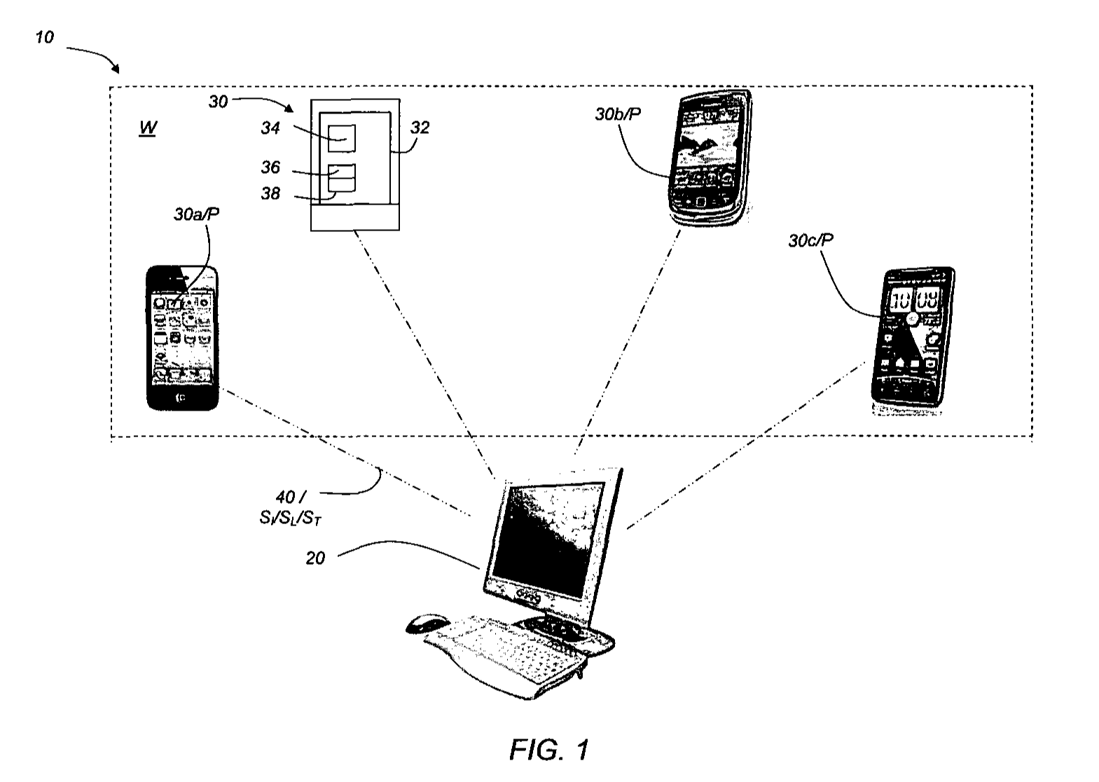

The present invention includes methods for verifying a worker's time and attendance at an appointed location, or work site, during an appointed time, or work shift. An embodiment of such a method is depicted by the flow chart of FIG. 1.

As a prelude to the ensuing description of embodiments of systems, apparatuses and methods that incorporate teachings of the present invention, a worker and a provider must establish a working relationship before the worker's attendance at an assigned worksite and the worker's time at the assigned worksite are monitored. All types of working relationships are within the scope of the present invention, including employer-employee relationships, independent contractor relationships, and the like.

Once a working relationship has been established between a provider and a worker, the provider may enable the worker to access a monitoring station, or central controller, through which the worker may report his or her attendance and time spent at an assigned worksite and the provider may verify that the worker has attended the designated worksite and monitor the amount of time the worker has spent at the designated worksite.

In the schematic representation of FIG. 1, a system 10 that incorporates teachings of the present invention is depicted. In the depicted embodiment, the system 10 includes a central controller 20, a plurality of mobile tracking devices 30a, 30b, 30c, etc. (collectively “mobile tracking devices 30”) and at least one communication network 40 that enables the mobile tracking devices 30 to communicate with the central controller 20.

In various embodiments, the central controller 20 may comprise a computer. The central controller 20 may be maintained and operated by a provider, or it may be maintained and operated by a third party, which offers time and attendance management services to one or more providers.

The central controller 20 is configured (e.g., programmed, etc.) verify a worker's W attendance at a designated worksite P and, optionally, to monitor the amount of time the worker W spends at the designated worksite P. The central controller 20 receives one or more signals S_{L} from each of the mobile tracking devices 30. Without limiting the scope of the present invention, the signal(s) S may include an identity signal S_{I}, a location signal S_{L} and a time signal S_{T}, or any combination of the foregoing. Signals S_{I}, S_{L} and S_{T} correspond respectively to the identity of the worker W, the worker W's location and the time the worker W was at that location. The signal(s) S may be transmitted by the mobile tracking devices 30 and received by the central controller 20 in any suitable manner within the ability of one of ordinary skill in the art.

Upon receiving any signal(s) S or corresponding data, the central controller 20 may process the data to confirm or verify that the appropriate individual (i.e., a worker W to which the data corresponds) was present at the designated worksite P at the appropriate time. In some embodiments, the data processed by the central controller 10 may also verify that the worker W was present at the designated worksite P for a pre-assigned duration of time.

Additionally, the central controller 20 may be programmed or otherwise configured to enable a provider to schedule one or more workers W for work at one or more designated worksites P. In such an embodiment, the central controller 20 may be configured to execute a program that displays one or more worksites P and the time(s) at which a worker W is needed at each worksite P. The worker W may then select from the available times, thereby scheduling himself or herself for work. At or after the scheduled time, the central controller 20 may compare identity, location and time data with the scheduled information to determine whether or not a worker W met his or her selected work obligation.

In some embodiments, the central controller 20 may be further programmed or otherwise configured to assist the worker W and/or the provider at the designated worksite P. Without limiting the scope of the present invention, the central controller 20 may be programmed to manage inventory, data collection and/or other tasks for a provider, including tasks that are specific to each worksite P.

The mobile tracking device 30 used by each worker W may comprise any device suitable for generating signals that carry, or correspond to, the type(s) of data that is to be processed by the central controller 20, and for transmitting that data to the remotely located central controller 20. Thus, the mobile tracking device 30 may be configured to enable a provider to verify that each of its workers W (and not another person using that worker W's mobile tracking device 30) is present at their designated worksite P at their appointed time. Accordingly, a mobile tracking device 30 may include at least one signal transmission element 32, an identity verification element 34, a location verification element 36 and, optionally, a time verification element 38.

In a specific embodiment, the mobile tracking device 30 may comprise a cellular telephone, or mobile telephone. In more specific embodiments, a variety of conventional mobile telephones, including mobile telephones owned and controlled by the workers W, may be used as the mobile tracking device 30. In such embodiments, a camera on the mobile telephone may comprise the identity verification element 34. The camera, when used in conjunction with a site-specific location identifier ID at the designated worksite P, and/or the GPS transceiver of the mobile telephone may comprise the location verification element 36. The time verification element 38 may be the mobile telephone's internal clock. Alternatively, the time verification element 38 may comprise a clock external to the mobile telephone, such as a clock that provides time to users of a cellular network on which the mobile telephone is used or a clock of the central controller 20.

The communication network 40 enables signals from the mobile tracking device 30 to be transmitted at least partially to the central controller 20. In embodiments where the mobile tracking device 30 comprises a mobile telephone, the communication network 40 may include a cellular network. Of course, the communication network 40 may also employ satellites (e.g., satellite transmitter, communications satellite and satellite receiver, etc.), fixed line elements or other communication elements that enable a signal generated by the mobile tracking device 30 or at least the data that corresponds to such a signal to be transmitted to the central controller 20.

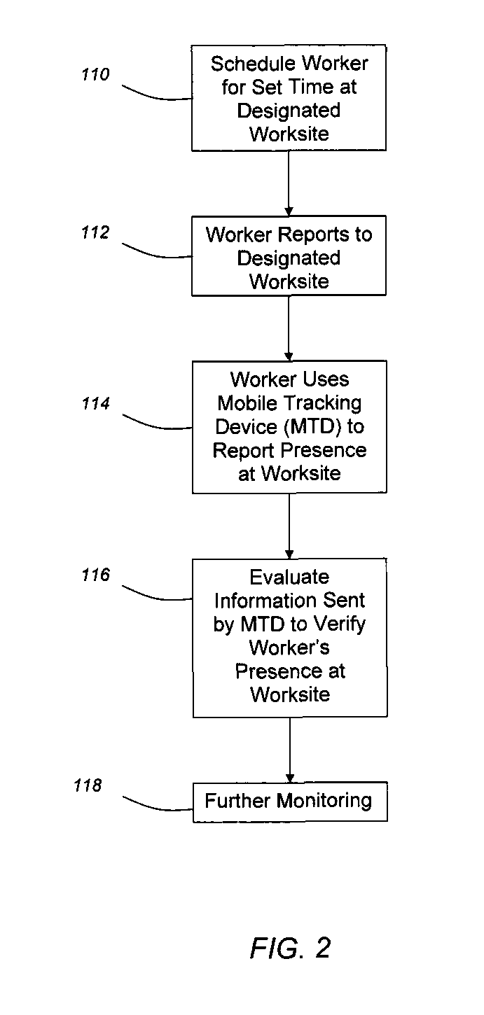

Turning now to FIG. 2, and with continued reference to FIG. 1, process flow of an embodiment of a method for monitoring a worker W's (FIG. 1) presence and time spent at a designated worksite P (FIG. 1) is illustrated. At reference 110 of FIG. 2, the worker W is scheduled to appear at a designated worksite P at an assigned time for a specified duration of time.

When the time assigned for the worker W to appear at the designated worksite P approaches, the worker W appears at the designated worksite P, as represented by reference 112 of FIG. 2. At that time, or shortly thereafter, the worker W uses the mobile tracking device 30 to verify that he or she is present at the designated worksite P, at reference 114 of FIG. 2. Such verification may comprise the generation and transmission of one or more signals S by the mobile tracking device 30. The signals S may be transmitted in any suitable form, such as by way of a text message (e.g., SMS, MMS, etc.), e-mail, or telephone call to a predetermined location. That predetermined location may be accessible by the central controller 20, or it may comprise some component (a “receiver 22”) of the central controller 20 itself.

At reference 116 of FIG. 2, data (e.g., image data, etc.) that corresponds to one or both of the location signal S_{L} and the identity signal S_{I} may be compared with a known location indicator for the designated worksite P and a known identifier for the worker W. Such a comparison may be effected by the central controller 20, or the central controller 20 may store the data for subsequent manual comparison.

In some embodiments, the worker W's continued presence at the designated worksite P may be further monitored at reference 118 of FIG. 2. Further monitoring may be effected one or more times, intermittently or continuously. Further monitoring may be effected by way of signals S that are generated by the worker W's mobile tracking device 30 (e.g. by the GPS transceiver, etc.) and sent by the mobile tracking device 30 to the central controller 20 until the worker W leaves the designated worksite P. In some embodiments, as long as a worker W remains at that designated worksite P (e.g., until the worker W “clocks out” by sending a shift termination signal to the central controller 20, etc.), a location signal S_{L} may be repeatedly (e.g., continuously, intermittently, etc.) transmitted from a tracking device 30 to the central controller 20. Transmission of the location signal S_{L} in this manner may be effected under control of the tracking device 30 (e.g., by way of a software application that remains active, or “on,” while the or by the central controller 20. As another example, further monitoring may be effected as the worker W logs into and out of a computer terminal at the designated worksite W.

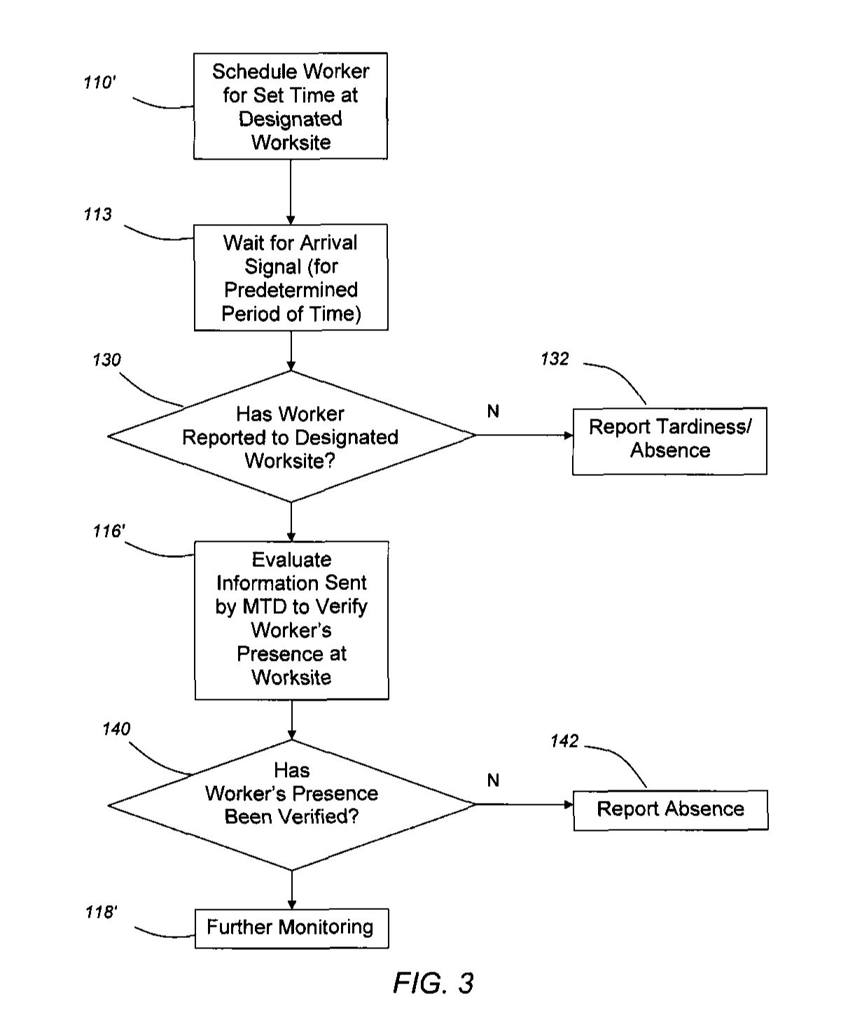

FIG. 3 is a flow chart that depicts an embodiment of a method for monitoring a worker W's time that may include the elements of the method illustrated by and described in reference to FIG. 2, and includes additional elements. In particular, the method depicted by the flow chart of FIG. 3 includes one or more decision points, such as one or both of the decision points represented by reference 130 and reference 140.

With continuing reference to FIG. 1, the decision point of reference 130 of FIG. 3 follows reference 113, where the central controller 20 waits for an arrival signal from the worker W; i.e., for the worker to arrive at the workplace P (at reference 112 of FIG. 2) and report his or her presence at the worksite P (at reference 114 of FIG. 2). The central controller 20 may begin waiting for an arrival signal from the worker W at a predetermined time (e.g., fifteen minutes, ten minutes, five minutes, etc.) before the worker W is scheduled to arrive at the designated worksite P (the beginning of a “waiting period”). The process of waiting may continue until the worker W sends an appropriate signal S (e.g., with the mobile tracking device 30, etc.) from the designated worksite P to the central controller 20, or for a predetermined amount of time (e.g., five minutes, ten minutes, fifteen minutes, etc.) after the worker W was scheduled to arrive at the designated worksite P (the end of the waiting period).

If at reference 130, the central controller 20 did not receive an appropriate signal S during the waiting period, process flows to reference 132, where the central controller notifies one or more of the provider, the worker W's supervisor and the worker W of the scheduled arrival time and the lack of any indication that the worker has arrived at the designated worksite P.

If, at reference 130, the central controller 20 did receive an appropriate signal S during the waiting period, process may flows to reference 116, where the received signals may be compared with known information (or data).

Decision point 140 of FIG. 3 follows reference 116. At decision point 140, a determination is made as to whether or not the signals S or corresponding data received by the central controller correspond to known information (or data), such as a known identifier from the designated worksite P and/or a known identifier for the worker W. If the determination at reference 140 is that the received signals do not match up with the corresponding known information, process flows to reference 142, where one or both of the provider and the worker W's supervisor may be notified that the worker W may not be present at the designated worksite P. If, in the alternative, the determination at reference 140 is that the worker W is present at the designated worksite P, process may flow to reference 118, where further monitoring may occur while the worker W remains at the designated worksite P.

Although the foregoing description contains many specifics, these should not be construed as limiting the scope of the present invention, but merely as providing illustrations of some embodiments. Similarly, other embodiments of the invention may be devised which do not exceed the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. A time management system, comprising:
a central controller programmed to receive, monitor and maintain time information and corresponding attendance verification information for a plurality employees and to compare the attendance verification information to confirmed identifying information;
a plurality of mobile telephones, each mobile telephone of the plurality of mobile telephones used by an employee of the plurality of employees and including for providing the central controller with the time information and the corresponding attendance information; and
a communication network configured to enable each mobile telephone to communicate with the central controller.

2. The time management system of claim 1, wherein the central controller is programmed to coordinate operations for a plurality of vendors located remotely from the central controller.

3. The time management system of claim 1, wherein the plurality of mobile telephones comprises a plurality of standard mobile telephones.

4. The time management system of claim 3, wherein the communication network comprises a cellular communication network.

5. The time management system of claim 1, wherein the communication network comprises a cellular communication network.

6. The time management system of claim 1, wherein each mobile telephone of the plurality of mobile telephones includes at least one verification component for providing attendance verification information to the central controller.

7. The time management system of claim 6, wherein the at least one verification component of each mobile telephone employs at least one of:
a camera and an external location verification element present at a site from which the employee using the mobile telephone is to report; and
a global positioning satellite receiver.

8. The time management system of claim 7, wherein the at least one verification component includes an identity confirmation component for confirming that the employee is actually using the mobile telephone to report the time information and the corresponding attendance verification information to the central controller.

9. The time management system of claim 1, wherein at least one of a clock associated with the central controller, each mobile telephone of the plurality of mobile telephones and the communication network provides the central controller with the time information as the central controller receives a time signal from the mobile telephone.

10. A method for managing time and attendance for a plurality of employees, comprising:
providing each employee of a plurality of employees with:
reporting information for establishing communication between a mobile telephone used by that employee and a central controller located remotely from a work location assigned to each employee; and
instructing each employee to use the mobile telephone and the reporting information to report time and attendance information upon arriving at an assigned work location and upon leaving the assigned work location;
receiving the time and attendance information for each employee with the central controller; and
using the central controller to confirm each employee's attendance at the assigned work location for that employee and to compare the time and attendance information for each employee to a schedule and a location assigned to that employee.

11. The method of claim 10, further comprising:
assigning sales information to each employee based at least partially upon the time and attendance information reported by that employee to the central controller.

12. The method of claim 10, wherein instructing comprises instructing each employee to send a text message to the central controller.

13. The method of claim 10, wherein instructing comprises instructing each employee to send an attendance verification image to the central controller.

14. The method of claim 10, wherein receiving comprises receiving location information from the mobile telephone used by each employee to report the time and attendance information.

15. The method of claim 10, wherein receiving comprises receiving time information from at least one of the mobile telephone, a communication network by which the mobile telephone communicates with the central controller and a clock associated with the central controller.

16. The method of claim 10, further comprising:
providing a notification when an employee has not reported to a work location at a scheduled time.

17. The method of claim 16, wherein providing the notification comprises providing the notification to the employee.

18. The method of claim 16, wherein providing the notification comprises providing the notification to a supervisor of the employee.

19. A worksite, comprising:
a location verification element;
a work station in communication with a remotely located central controller; and
a mobile telephone for communicating with the central controller separately from the work station and for transmitting a signal representative of the location verification element and an identity of an employee present at the worksite to the central controller for verification of the identity of the employee.

20. The worksite of claim 19, wherein the location verification element is unique to the worksite.
